(19) United States
(12) Patent Application Publication
(10) Pub. No.: US 2021/0349452 A1
(43) Pub. Date: Nov. 11, 2021

(54) System and method for manufacturing a product having predetermined specifications

(71) Applicant: Tools for Smart Minds S.r.l., Castel Mella (BS) (IT)

(72) Inventor: Claudio Vivante, Poncarale (BS) (IT)

(21) Appl. No.: 17/283,239

(22) PCT Filed: Oct. 7, 2019
(86) PCT No.: PCT/IB2019/058522

§ 371 Date: Apr. 6, 2021

(30) Foreign Application Priority Data
Oct. 11, 2018 (IT) 102018000009382

(51) Int. Cl. G05B 19/418

(52) U.S. Cl. CPC G05B 19/41875; G05B 2219/32187; G05B 2219/32182; G05B 2219/32181

(57) ABSTRACT

A system for manufacturing a product having predetermined specifications includes a working station for manufacturing the product, which has a plurality of working operating parameters; first sensors for detecting first data regarding the working environment; second sensors for detecting second data regarding the plant where the system is installed; and a first control device operatively connectable to the working station and to the first and the second sensors, which has a storage unit containing a plurality of optimal operating parameters. During operation of the working station, the control device detects the first and the second data and compares the working operating parameters with the corresponding optimal operating parameters so as to detect deviations. A second device determines the optimal operating parameters during operation of the working station.

### FIELD OF THE INVENTION

The present invention is applicable in the technical field of installations, and it particularly regards a system and a method for manufacturing a product having predetermined specifications.

### STATE OF THE ART

In the industrial field it is known that the working parameters of a working station of a plant, such as for example temperature and pressure, impact the correct manufacturing of an industrial product, i.e. on the manufacturing of a product with predetermined specifications.

Thus, there arises the need to identify—for each plant—the optimal operating parameters with the aim of manufacturing a product having predetermined specifications. As a matter of fact, it is clear that an erroneous determination of the working operating parameters leads to manufacturing a faulty product with an evident waste of time, energy and material. Such disadvantage is even more evident in case of large and expensive plants such as for example a die-casting plant, an extrusion plant, a moulding plant, a firing furnace or the like.

The operating parameters are thus generally manually selected by a highly skilled operator. Such operation is particularly complex and expensive. Furthermore, the skilled operator is not able to correctly evaluate all the parameters. In any case there is the risk of manufacturing a product without the predetermined specifications, i.e. faulty.

A further inconvenience lies in the fact that when the environmental or process conditions change (even several times a day) without the modification of the working operating parameters, this leads to manufacturing faulty products.

Furthermore, the skilled operator cannot correctly evaluate all parameters simultaneously in real time, with the evident risk of intervening on the incorrect operating parameters thus manufacturing a faulty product.

Such disadvantages are particularly burdensome upon considering large plants such as die-casting plants or hot forming plants.

### SUMMARY OF THE INVENTION

An object of the present invention is to at least partly overcome the drawbacks illustrated above, by providing a system for manufacturing a product having predetermined specifications of high efficiency and low costs.

Another object of the present invention is to provide a system for manufacturing a product having predetermined specifications capable of allowing to signal faulty products in advance.

Another object of the present invention is to provide a system for manufacturing a product having predetermined specifications capable of modifying the working operating parameters of the plant automatically so that the products have the predetermined specifications.

Another object of the present invention is to provide a system comprising a die-casting or hot forming station for manufacturing a product having predetermined specifications.

A further object of the present invention is to provide a method for manufacturing a product having predetermined specifications of high efficiency and low costs.

These objects, just like others that will be more apparent hereinafter, are attained by a system and a method for manufacturing a product having predetermined specifications as described, illustrated and/or claimed herein.

The dependent claims describe advantageous embodiments of the invention.

### BRIEF DESCRIPTION OF THE DRAWINGS

Further characteristics and advantages of the invention will be more apparent in light of the detailed description of a preferred but non-exclusive embodiment of the invention, illustrated by way of non-limiting example with reference to the attached drawings, wherein:

FIGS. 1 and 2 are block diagrams exemplifying some steps of the method for manufacturing a product having predetermined specifications.

### DETAILED DESCRIPTION OF SOME PREFERRED EMBODIMENTS

Herein described is a system and a method for manufacturing a product having predetermined specifications.

The expression predetermined specifications is used to indicate specifications relating to the quality of the product, for example the number of cracks per product, the amount of product, for example the number of pieces per hour, the duration of the plant, the scheduling of maintenance, for example the working hours and shutdown hours or the like. In other words, the expression predetermined specifications is thus used to indicate one or more objectives to be met.

Such specifications may then also be verified by means of suitable product quality and/or quantity sensors, or by means of the working station soundness state sensors.

For example, such sensors may include vision systems of the per se known type. Possibly, such specifications may be verified by an operator.

Thus, the system may comprise at least one working station for manufacturing the product that may be finished or semi-finished.

More generally, the system may be suitable for manufacturing any type of product. For example, the working station may be part of a die-casting plant, an extrusion plant, a moulding plant, a furnace or the like.

Essentially be provided for may be sensors for detecting data regarding the working environment, sensors for detecting data regarding the plant, at least one control device and a data storage unit, all of which may be operatively connected with each other.

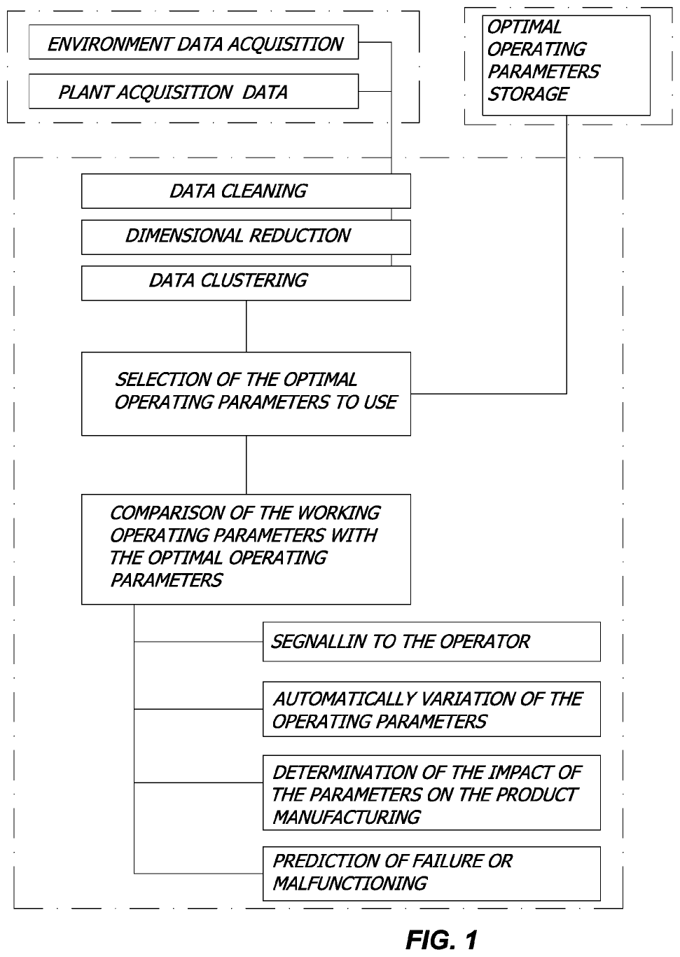

FIG. 1 schematically illustrates an embodiment in which the activities carried out respectively by the sensors (data acquisition), by the storage unit (data storage) and by the control device are gathered and surrounded by a dashed line.

The sensors relating to the environment may be pressure, temperature and/or humidity sensors. The expression “environment” is used to indicate the environment in which the working station is placed. For example, for example it may be the temperature and the humidity in a shed, or it may be the atmospheric temperature and humidity if the station is located outdoors or it may be the temperature and humidity of a controlled environment (for example a climatic chamber).

On the other hand, the sensors regarding the plant may be of different types depending on the data to be detected. They may be pressure, temperature and humidity sensors as well as sensors for detecting mechanical absorptions such as torque absorption, for detecting vibrations or speed, for evaluating energy absorptions or the like.

Such sensors may be of per se known type in the industrial sector, such as for example thermocouples, thermometers, thermistors, resistance thermometers and/or pyrometers.

In any case, all sensors may be operatively connected with the control device so that the latter receives the data detected by the former.

The storage unit may contain a plurality of optimal operating parameters, i.e. The values of the operating parameters that allow to manufacture the product with the predetermined specifications.

Such optimal operating parameters are stored so as to be correlated to the data detected by the sensors regarding the working environment and the plant.

Suitably, during the operation of the working station, the control device may detect the data relating to the working environment and to the plant so as to select the corresponding optimal operating parameters, and thus compare such optimal operating parameters with the corresponding working operating parameters.

The working station may thus have specific working operating parameters. For example, the working station may be a moulding station and the working operating parameters may thus be the closing pressure, the closing and/or opening speed, the closing times or the like.

In particular, the device may thus compare the working operating parameters with the optimal operating parameters and determine the deviation of the former from the latter.

The device may alert an operator on the deviations between the working operating parameters and the optimal operating parameters and/or, as better explained hereinafter, it may act on the working station so that the latter operates with the stored optimal operating parameters.

Suitably, such deviation may also be signalled by means of sound and/or light signalling means or by means of operating screens arranged in proximity of the plant or remotely visible by an operator.

Furthermore, the signalling means may signal—to the operator—that the product undergoing the manufacturing has specifications different from the predetermined specifications.

Thus, thanks to such characteristic, it may be provided for that the manufactured product does not meet the predetermined specifications before the product is manufactured or before it is finished. For example, an alert signal indicating that with such speed of the screws the extruded product will have poor mechanical resistance and thus will not meet the predetermined specifications, may be sent to the operator in case of an extrusion station.

In other words, the system may provide indications of the predictive type. More generally, the device may provide a predictive model of the working station, i.e. a model capable of predicting both the information regarding the product to be manufactured and regarding the state of the plant, for example risks of failure and/or malfunctioning.

Suitably, the control device may comprise a data processing logic unit operatively connected with the sensors and with the storage unit so as to determine the impact of the data detected by the sensors for manufacturing a product having determined specifications.

For example, such operation may be carried out by means of dimensional reduction techniques.

More in particular, the logical unit may determine the impact of each data and/or operative parameter on the manufacturing of the product with the predetermined specifications. In this manner, it may be determined which data among the ones detected by the sensors substantially have no impact for the manufacturing of the product having predetermined specifications.

The expression “determine impact” is used to indicate determining how much the manufactured product varies based on the variation of such data/operative parameter. Such operation may be carried out by means of correlations of the static type. For example, if such impact is lesser than a predetermined value the data/parameter may be considered substantially unimpactful.

For example, it may be determined that the variation of the humidity detected by the sensors is unimpactful with respect to the manufacturing of the piece moulded without cracks, while the temperature variation detected by the sensors between summer/winter considerably impacts the number of pieces without the required specifications, i.e. with a high number of cracks.

It is clear that a data processing logic unit may be connected with signalling means so that the latter signal the impact of one or more data to the operator.

This will allow to optimise the production processes. As a matter of fact, the signalling means may signal—in real time to the operator—which operating parameters and/or which data detected by the sensors are unimpactful or scarcely impactful with the aim of manufacturing the product with the predetermined specifications.

The control device may also act on the working station, i.e. on the working operating parameters thereof to automatically vary one or more of such parameters so that such parameters have the values of the optimal operating parameters.

As described above, the optimal operating parameters may thus be pre-stored in a special storage unit, for example by connecting to a remote data base. On the other hand, such optimal operating parameters may be calculated—for that specific working station —starting from the detected data.

In this manner, the optimal operating parameters may be extremely precise and they may be specific for that single working station in those single working conditions in that time instant.

A second calculation device for determining the optimal operating parameters which may be connected with the first and second sensors for detecting data regarding the environment and the plant may be suitably provided for. Furthermore, the calculation device may comprise further sensors for detecting data regarding the quality of the manufactured product.

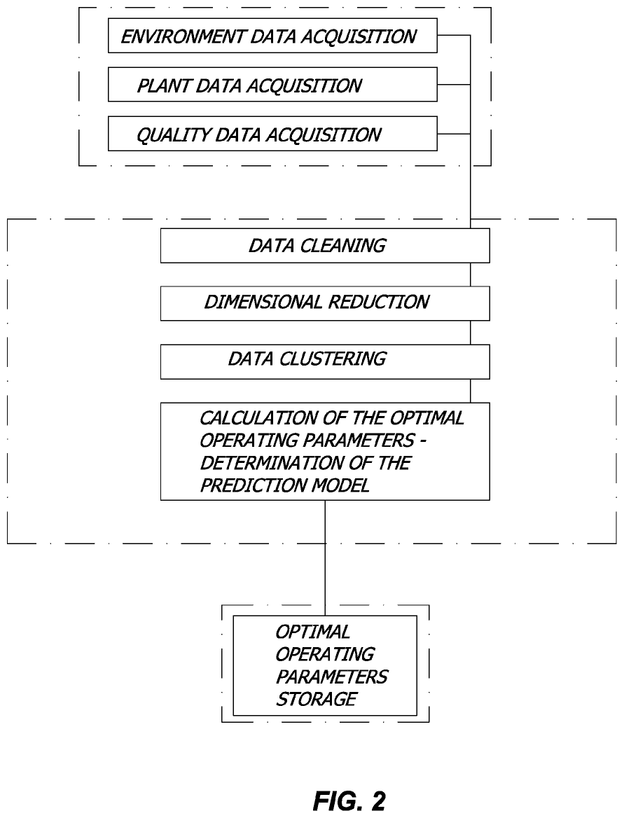

FIG. 2 schematically shows an embodiment highlighting the different steps for calculating the operating parameters. The steps are gathered by a dashed line which identifies the sensors, the calculation device and the storage unit.

It is clear that the storage unit may be single and it may be thus operatively connected with the control device and with the calculation device.

This latter data substantially regards meeting the predetermined specifications and/or the deviation from such specifications. It is clear that the expression “meeting” is used to indicate compliance with the predetermined specifications with a given range of statistical type. For example, a predetermined specification may be that 97% of the pieces be without cracks, that the average density be greater than a predetermined value.

A data processing logic unit for calculating the optimal operating parameters of the plant starting from all data detected by the sensors may be suitably provided for.

Upon calculating the optimal operating parameters, the latter are stored in the storage unit so that can be used by the control device.

The calculated optimal operating parameters may possibly replace the operating parameter values already present in the storage unit.

Thus, with the aim of determining the optimal operating parameters a step for the acquisition of data regarding the plant and data regarding the working environment may be operatively provided for. Such data may be detected by means of suitable sensors of per se known type positioned in proximity of the plant.

Some data may be possibly detected by suitable databases in loco or remote. For example, the data regarding the type of material, the type of plant, the type of product to be manufactured, or the like.

Such data may be stored in the storage unit and it may be cleaned of electrical disturbance and/or periodicity using filtering techniques of per se known type.

Furthermore, the data may be temporarily correlated and suitably organised so as to be easily available for the subsequent operations, like those of comparison with the working operating parameters.

The collected data may be aggregated using “clustering” techniques of per se known type so that the data regarding the same phenomenon are gathered and identified automatically. In this manner, for example, the temperature indicating the moulding temperature, the opening temperature, the inoperative temperature may be distinguished automatically from among detected temperatures.

Such operations are carried out by the data processing logic unit which is thus operatively connected to the storage unit and, possibly, with one or more data detection sensors and/or with company databases.

Furthermore, the correlation of the detected data may allow to automatically identify the process stages thus defining a so-called “finite-state machine”.

For example, in case of moulding, low temperatures for a determined time interval and high temperatures for a determined time interval may be detected alternatively. In this manner, it may be automatically detected when the mould is closed and when the mould is open.

Furthermore, the transition phases between the states may also be detected, for example by means of predetermined linear, jerky or curved temperature ramps.

In other words, data regarding the plant and the environment may be detected continuously so as to determine a modelling of the plant like a “finite-state machine” and the working operating parameters may be detected simultaneously.

In any case, the control device suitable to modify the working operating parameters so that they are optimal operating parameters, and the device for determining the optimal operating parameters may operate simultaneously during the operation of the working station.

In this manner, the optimal operating parameters may be always advantageously modified automatically each time there is a change of one or more data, i.e. each time the operative conditions or the product specifications change, so that the working station has a maximum machining effectiveness.

In this manner, the optimal operating parameters may vary automatically depending on the data relating to the environment, i.e. depending on the hours of the day, of the seasons, or the like.

Furthermore, in light of the above, a prediction model which may thus allow to schedule the maintenance and machine shut-down activity may be defined, same case applying to establishing on which aspects of the working station should be subject of intervention so as to optimise the production of the finished or semi-finished products.

It is clear that when using expressions relating to prediction, estimation, determination, evaluation, should always be considered a statistical indication, i.e. the data/fact with a given probability within a given time interval.

According to a particular embodiment, the system may comprise a working station for the hot forming of a product starting from a material to be moulded for manufacturing a product having predetermined specifications. For example, such products may be a valve, a cooking pan, a fitting, or the like.

Preferably, the material to be moulded may be a polymeric or composite material.

Essentially, the moulding station may comprise a furnace for heating the material to be moulded, a mould, at least one press acting on the mould to promote the opening and/or closing thereof and drive means acting on the press for displacing the latter.

Furthermore, means may be suitably provided for promoting the advancement of the material to be machined from said second furnace to said second mould.

Thus, such station may be of the per se known type.

The sensors for detecting data regarding the environment may be thermometers, hygrometers or barometers arranged in proximity of the machining station and/or spaced therefrom in the work environment. For example, should the machining station be arranged inside a shed, such sensors may be positioned therein.

The sensors may be configured to detect one or more of the temperatures in the furnace, the mould, the inner surfaces thereof, same case applying to the temperatures of the material to be moulded in the furnace, during the advancement between the furnace and the mould, in the mould, at the outlet of the latter.

The sensors may also detect the through-flow speed of the semi-finished products in the furnace, the maximum force of the power hammer in the press, the power of the power hammer, the impact speed, just like they may detect the type of material, for example by means of the melting temperature.

The data regarding the quality of the end product, may be an index of the quality detected by the quality control, for example a numerical value. This value may be entered by the operator by means of means of per se known type, such as for example a touch-screen. Possibly, meeting the specification of the quality of the product may be detected automatically, for example by means of vision systems of per se known type, such as video cameras.

Thus, the product specifications may be those aimed at obtaining faultless products. The operating parameters of the plant may be the temperature in the furnace, the through-flow speed of the semi-finished products in the furnace, maximum force of the power hammer in the press, power of the power hammer and impact speed which may thus be modified in a per se known manner, for example by means of resistors, motors, or the like.

Sensors may be possibly provided for detecting the vibrations of the mould, the absorptions of the motors, the pressure of the hydraulic circuits and/or the temperatures of the displacement members, such as robotic arms, pistons, or the like.

During the machining, the system may compare such operating parameters with the stored optimal parameters. Upon detecting a deviation, the system may thus alert the operator, and/or correct such deviation automatically.

For example, should the temperature of the material in the mould be lower than the optimal temperature, the power of the furnace may be increased so that the material increases the temperature thereof or the advancement of the material from the furnace to the mould may be quickened.

Furthermore, upon manufacturing the product and verifying the congruence or the deviation from the required specifications, the system may store the operating parameters that caused such deviation same case applying to storing that some optimal parameters do not guarantee the meeting of such specifications.

In other words, even the stored optimal parameters are modified during the operation of the station based on the data detected by the sensors and the meeting or deviation of the product from the required specifications.

As described, the system may signal—to the operator—which parameters are impactful towards the manufacturing of product with the desired specifications, i.e. without defects. The operating parameters may be possibly automatically modified so as to reach the optimal parameters with which to obtain products without defects.

For example, the operator may be notified that the through-flow speed in the furnace is too high, and that such parameter is crucial towards manufacturing the product without defects. The system may possibly automatically reduce the through-flow speed and/or alert the operator that such speed is too high.

Furthermore, the operator may be notified that the variation of the temperature in the furnace does not considerably affect the manufacturing of the end products and it could be reduced. This may allow to avoid expensive operations for maintaining the temperature in the furnace constant without jeopardising the quality of the end products.

According to a different embodiment, the machining station may be a die-casting station for manufacturing the product having predetermined specifications starting from a material, preferably metallic. For example, such material may be aluminium.

Essentially, the die-casting station may comprise a furnace for housing the material to be machined, a mould and a press acting on the mould for promoting the opening and/or closing thereof so as to manufacture the product with predetermined specifications, drive means acting on the press to displace the latter and at least one robotic arm for loading the material to be machined in the mould.

Similarly to the above, the sensors may be configured to detect one or more of the temperatures in the furnace, the mould, the inner surfaces thereof, same case applying to the temperatures of the material in the furnace, during the displacement between the furnace and the mould, in the mould, at the outlet of the latter.

Furthermore, the sensors may detect the displacement speed of the robotic arm, the opening and closing speed of the mould, same case applying to the speed of the press, and/or the absorptions in the latter, i.e. In the drive means acting on the robotic arm and on the press. Suitably, the sensors may automatically recognise the type of material, for example by means of the chemical-physical characteristics thereof, such as for example the melting temperature or by means of a spectrometry, or other similar methods.

Furthermore, the sensors may possibly detect the vibrations of the press and/or of the mould and/or of the robotic arm.

Similarly to what is described above, the system may compare the operating parameters with the optimal parameters and with the quality of the product. Following such comparison, the system may intervene automatically and/or signal—to the operator—the deviation of the operating parameters with respect to the optimal parameters.

According to a further embodiment, the system may comprise a working station which may be a hot coating station. Thus, the station may comprise a robot for spraying powder paint on a semi-finished product which must be coated, which is then hung on a chain which passes through a firing furnace, so that the paint bonds to the semi-finished product.

The data detected by the sensors regarding the environment may be the temperature of the environment and the humidity of the temperature.

The detected data regarding the plant may be the temperature of the zones of the firing furnace, temperature ramp of the furnace, the through-flow speed of the semi-finished product in the furnace, time between the deposit of the paint on the semi-finished product and the entry into the firing furnace, the type of powder paint, the type of product to be manufactured.

The data regarding quality may be an index of the quality detected by the quality control, for example a numerical value. 0=good piece, 1=discarded with defect of type A, 2=discarded with defect of type B, 3=discarded with defect of type C).

Thus, the product specifications may be those aimed at obtaining faultless products. The operating parameters of the plant may thus be the temperature of the areas of the firing furnace, the through-flow speed of the semi-finished product in the furnace, the time between the deposit of the paint on the semi-finished product and the entry into the firing furnace.

The system may thus identify which parameters impact the occurrence of defects which thus lead to manufacturing a product not having predetermined specifications.

Incorrect parameters, i.e. different from the optimal operating parameters, may be signalled to the operator in this case too. Such operating parameters may be possibly automatically modified by the system so as to reach the optimal parameters with which to obtain products without defects.

For example, if the temperature data of the firing furnace is incorrect, the system specifically identifies the temperature of the furnace as the operative parameter to be modified. Such temperature may be modified in a per se known manner, for example by means of burners arranged in the furnace.

Furthermore, the system may possibly signal that the temperature ramp used for heating the furnace does not impact the manufacturing of the product having the desired specifications. In addition, it may signal that it is not optimised.

In other words, the system according to the invention may also allow an optimisation of the plant and/or reduce the costs thereof.

In light of the above, it is clear that the invention attains the pre-set objectives. The invention is susceptible to numerous modifications and variants. All details can be replaced by other technically equivalent elements, and the materials can be different depending on the technical needs, without departing from the scope of protection of the invention defined by the attached claims.

The invention claimed is:

1.-29. (canceled)

30. A system for manufacturing a product having predetermined specifications, comprising:
a working station configured to manufacture the product, the working station having a plurality of working operating parameters;
first sensors for detecting first data relating to a work environment;
second sensors for detecting second data relating to the working station;
a first control device operatively connectable to the working station and to the first and the second sensors;
a storage unit having a plurality of optimal operating parameters stored therein, the storage unit being operatively connected to the first control device,
wherein, during operation of the working station, the first control device detects the first and the second data and compares the working operating parameters with corresponding optimal operating parameters, the first control device detecting a deviation of the working operating parameters from the corresponding optimal operating parameters;
third sensors for detecting third data related one or both of quality of the product, quantity of the product, or soundness of the working station; and
a second device for calculating the optimal operating parameters, the second device being operatively connected with the first, the second, and the third sensors and comprising a first data processing logic unit configured to calculate the optimal operating parameters of the working station starting from the first, the second, and the third data,
wherein the storage unit is operatively connected to the second device so as to store the calculated optimal operating parameters; and
a first signaling system that signals, to an operator, the deviation between the working operating parameters and the optimal operating parameters,
wherein the first control device is configured to predict information regarding both the product to be manufactured and a state of a plant where the system for manufacturing the product is installed, so as to predict whether a manufactured product meets the predetermined specifications before the product is manufactured or before it is finished,
wherein the first control device acts on the working operating parameters of the working station to vary one or more parameters so that the working operating parameters have a value of the optimal operating parameters, and
wherein the first control device and the second calculation operate simultaneously during the operation of the working station, so that the optimal operating parameters are always advantageously modified automatically each time there is a change of one or more of the first, the second, or the third data.

31. The system according to claim 30, wherein the first signaling system signals, to the operator, that the product under manufacturing has specifications different from system specifications.

32. The system according to claim 30, wherein the first device comprises a second data processing logic unit operatively connected to the first sensors, the second sensors, the second device, and the storage unit so as to determine and impact of the first and/or the second data on a manufacture of the product having predetermined specifications.

33. The system according to claim 32, wherein the second data processing logic unit is operatively connected with the signaling system to alert the operator about the impact of the first and/or the second data on the manufacture of the product having predetermined specifications.

34. The system according to claim 30, wherein the first sensors include pressure, temperature and/or humidity sensors of an environment in which the plant is located.

35. The system according to claim 30, wherein the second sensors include pressure, temperature, torque, vibration, speed and/or energy absorption sensors.

36. The system according to claim 30, wherein the third sensors are sensors of the quality and the quantity of the product, or sensors of the soundness of the working station.

37. A method of manufacturing a product having predetermined specifications with a system according to claim 30, the method comprising:
determining the optimal operating parameters of the working station so as to obtain the product having predetermined specifications,
wherein determining the optimal operating parameters comprises:
acquiring the first data regarding the working environment;
acquiring the second data regarding the working station;
acquiring the third data regarding one or both of the quality and the quantity of the product;
calculating the optimal operating parameters of the working station starting from the first, the second, and the third data with the first data processing logic unit, wherein the first, second, and the third data relate to a same machining step; and
storing the optimal operating parameters in the storage unit;
the method further comprising:
acquiring fourth data regarding the working environment;
acquiring fifth data regarding the working station;
selecting the optimal operating parameters by the storage unit; and
comparing the optimal operating parameters with the working operating parameters of the working station during use using a second data processing logic unit, the second data processing logic unit being operatively connected with the storage unit;
wherein the step of selecting the optimal operating parameters and the step of comparing the optimal operating parameters with the working operating parameters are carried out continuously during the operation of the working station;
the method further comprising:
predicting information on the product to be manufactured and the state of the plant, so as to predict whether a manufactured product meets the predetermined specifications before the product is manufactured or before the product is finished;
varying one or more parameters so that the working operating parameters have the value of the optimal operating parameters;
determining the deviation of the working operating parameters with respect to the optimal operating parameters; and
signaling, to the operator, the deviation of the working operating parameters and the optimal parameters.
